(19) United States
(12) Patent Application Publication
(10) Pub. No.: US 2010/0329084 A1
(43) Pub. Date: Dec. 30, 2010

(54) Clock Having Diverse Ornamental Variations

(76) Inventor: Shanker Mo, Wu-Chi Town (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/494,619

(22) Filed: Jun. 30, 2009

(51) Int. Cl. G04B 47/04

(52) U.S. Cl. 368/285

(57) ABSTRACT

A clock includes a tumbler and a decorative scale unit including a plurality of decorative scales surrounding the tumbler. Thus, the clock has an outstanding outer appearance by the decorative scales of the decorative scale unit. In addition, a smaller one of the decorative scales of the decorative scale unit is received in a larger one of the decorative scales so that the decorative scales encircle each other before assembly to reduce the whole volume of the decorative scale unit, thereby facilitating packaging, storage and transportation of the clock. Further, the decorative scales are arranged arbitrarily to form different geometric shapes according to the requirements of different users, thereby greatly enhancing the aesthetic quality of the clock.

### BACKGROUND OF THE INVENTION

1. Field of the Invention

The present invention relates to a time indicating device and, more particularly, to a clock to indicate the instant time.

2. Description of the Related Art

A conventional clock comprises a panel and a tumbler mounted on the center of the panel. The panel has a surface provided with a plurality of time indicating scales surrounding the tumbler. However, the panel only has a time indicating function and cannot provide an ornamental effect, thereby greatly decreasing the aesthetic quality of the clock. In addition, the clock is assembled previously so that the shape and pattern of the clock cannot be changed according to a user's requirement. Further, the clock has a fixed structure so that the clock has a larger volume, thereby causing inconvenience in packaging, storage and transportation of the clock.

### BRIEF SUMMARY OF THE INVENTION

In accordance with the present invention, there is provided a clock, comprising a tumbler and a decorative scale unit including a plurality of decorative scales surrounding the tumbler.

In addition, the tumbler is located at a center of the decorative scales of the decorative scale unit, and the decorative scales of the decorative scale unit are arranged to form a geometric shape. In addition, the decorative scales of the decorative scale unit have different sizes. In addition, the sizes of the decorative scales are reduced gradually according to a determined proportion. In addition, the decorative scales of the decorative scale unit have the same shape. In addition, each of the decorative scales of the decorative scale unit has a hollow structure. In addition, each of the decorative scales of the decorative scale unit has an inner portion provided with a receiving hole. In addition, the receiving hole of each of the decorative scales has a shape the same as that of each of the decorative scales of the decorative scale unit. In addition, the receiving hole of each of the decorative scales is arranged eccentrically in each of the decorative scales. In addition, a smaller one of the decorative scales of the decorative scale unit is received in the receiving hole of a larger one of the decorative scales so that the decorative scales encircle each other before assembly. In addition, the decorative scales of the decorative scale unit have different colors. In addition, the decorative scales of the decorative scale unit are located at different heights. In addition, the smallest one of the decorative scales of the decorative scale unit has a solid structure. In addition, at least one of the decorative scales of the decorative scale unit has a periphery provided with at least one hanging hole. In addition, the receiving hole of each of the decorative scales has a side provided with an image plate. In addition, the tumbler is attached to a wall, and the decorative scales of the decorative scale unit are attached to the wall.

The primary objective of the present invention is to provide a clock having diverse ornamental variations.

Another objective of the present invention is to provide a clock, wherein the decorative scale unit includes a plurality of decorative scales surrounding the tumbler so that the clock has an outstanding outer appearance.

A further objective of the present invention is to provide a clock, wherein a smaller one of the decorative scales of the decorative scale unit is received in a larger one of the decorative scales so that the decorative scales encircle each other before assembly to reduce the whole volume of the decorative scale unit, thereby facilitating and decreasing the cost of packaging, storage and transportation of the clock.

A further objective of the present invention is to provide a clock, wherein the decorative scales of the decorative scale unit are arranged arbitrarily to form different geometric shapes according to requirements of different users, thereby greatly enhancing the aesthetic quality of the clock.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a clock in accordance with the preferred embodiment of the present invention.

FIG. 2 is a front view of the clock as shown in FIG. 1.

FIG. 3 is a folded view of the clock as shown in FIG. 1.

FIG. 4 is a front view of the clock in accordance with another preferred embodiment of the present invention.

FIG. 5 is a front view of the clock in accordance with another preferred embodiment of the present invention.

FIG. 6 is a front view of a clock in accordance with another preferred embodiment of the present invention.

FIG. 7 is a folded view of the clock as shown in FIG. 6.

FIG. 8 is a front view of a clock in accordance with another preferred embodiment of the present invention.

FIG. 9 is a locally enlarged view of a decorative scale of the clock as shown in FIG. 8.

FIG. 10 is a schematic operational view of the decorative scale of the clock as shown in FIG. 9.

FIG. 11 is a perspective view of a clock in accordance with another preferred embodiment of the present invention.

FIG. 12 is a front view of a clock in accordance with another preferred embodiment of the present invention.

### DETAILED DESCRIPTION OF THE INVENTION

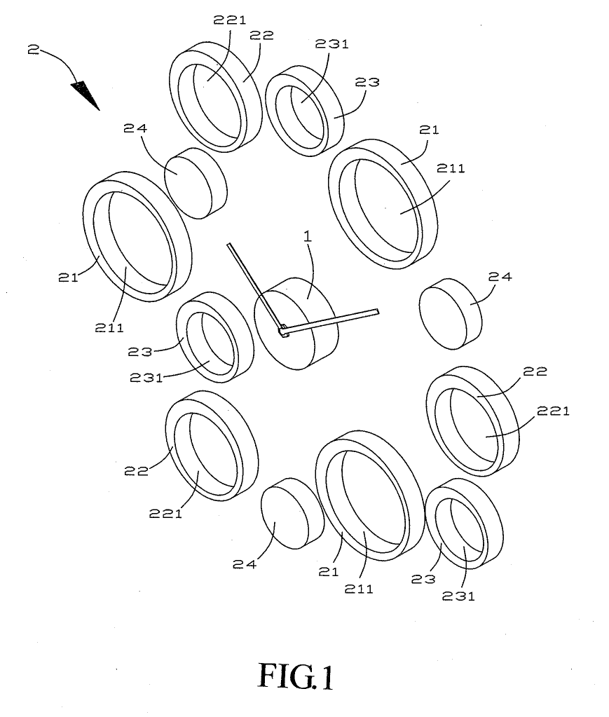

Referring to the drawings and initially to FIGS. 1-3, a clock in accordance with the preferred embodiment of the present invention comprises a tumbler 1 and a decorative scale unit 2 including a plurality of decorative scales 21, 22, 23 and 24 surrounding the tumbler 1.

The tumbler 1 is located at a center of the decorative scales 21, 22, 23 and 24 of the decorative scale unit 2. The tumbler 1 is attached to a wall by bonding or by nails.

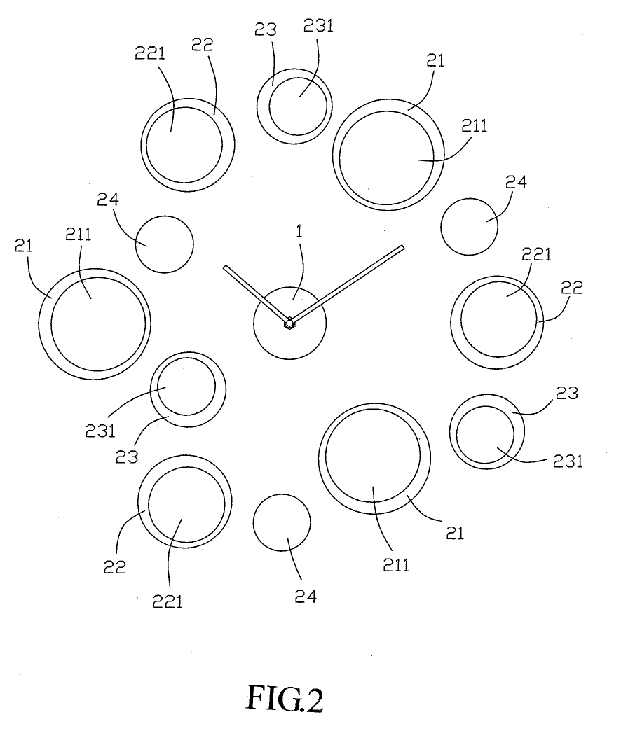

The decorative scales 21, 22, 23 and 24 of the decorative scale unit 2 are attached to a wall by bonding or by nails. The decorative scales 21, 22, 23 and 24 of the decorative scale unit 2 have different colors and are located at different heights. The decorative scales 21, 22, 23 and 24 of the decorative scale unit 2 are arranged to form a geometric shape according to a user's requirement. Preferably, the decorative scales 21, 22, 23 and 24 of the decorative scale unit 2 are arranged to form a loop-shaped profile. The decorative scales 21, 22, 23 and 24 of the decorative scale unit 2 have different sizes. The sizes of the decorative scales 21, 22, 23 and 24 are reduced gradually according to a determined proportion. The decorative scales 21, 22, 23 and 24 of the decorative scale unit 2 have the same shape. Preferably, each of the decorative scales 21, 22, 23 and 24 of the decorative scale unit 2 has a circular shape as shown in FIG. 2.

Each of the decorative scales 21, 22 and 23 of the decorative scale unit 2 has a hollow structure and has an inner portion provided with a receiving hole 211, 221 and 231. The decorative scale 24 of the decorative scale unit 2 has a solid structure. The receiving hole 211, 221 and 231 of each of the decorative scales 21, 22 and 23 is arranged eccentrically in each of the decorative scales 21, 22 and 23. The receiving hole 211,221 and 231 of each of the decorative scales 21, 22 and 23 has a shape the same as that of each of the decorative scales 21, 22, 23 and 24 of the decorative scale unit 2. Preferably, the receiving hole 211, 221 and 231 of each of the decorative scales 21, 22 and 23 has a circular shape.

In assembly, a smaller one of the decorative scales 22, 23 and 24 of the decorative scale unit 2 is received in the receiving hole 211, 221 and 231 of a larger one of the decorative scales 21, 22 and 23 so that the decorative scales 21, 22, 23 and 24 encircle each other before assembly to reduce the whole volume of the decorative scale unit 2, thereby facilitating packaging, storage and transportation of the decorative scale unit 2.

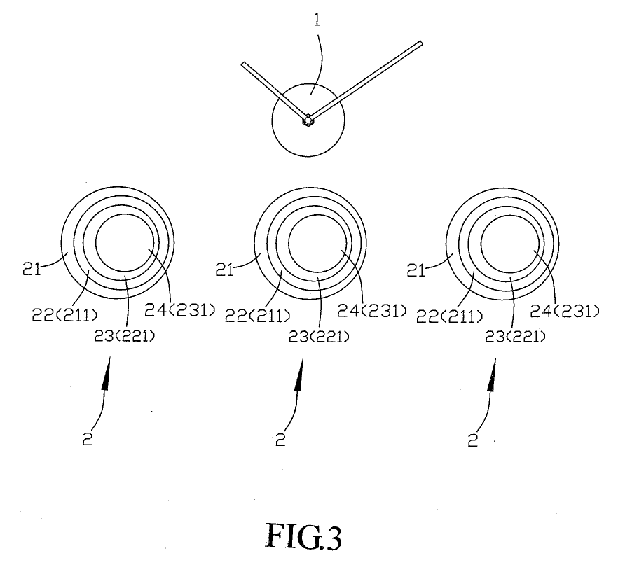

As shown in FIG. 3, the decorative scale 22 is received in the receiving hole 211 of the decorative scale 21, the decorative scale 23 is received in the receiving hole 221 of the decorative scale 22, and the decorative scale 24 is received in the receiving hole 231 of the decorative scale 23. Thus, the decorative scale 23 receives the decorative scale 24, the decorative scale 22 receives the decorative scale 23, and the decorative scale 21 receives the decorative scale 22, so that the decorative scales 21, 22, 23 and 24 are integrally combined together to construct the decorative scale unit 2 which forms a compact integrity, thereby facilitating packaging, storage and transportation of the decorative scale unit 2.

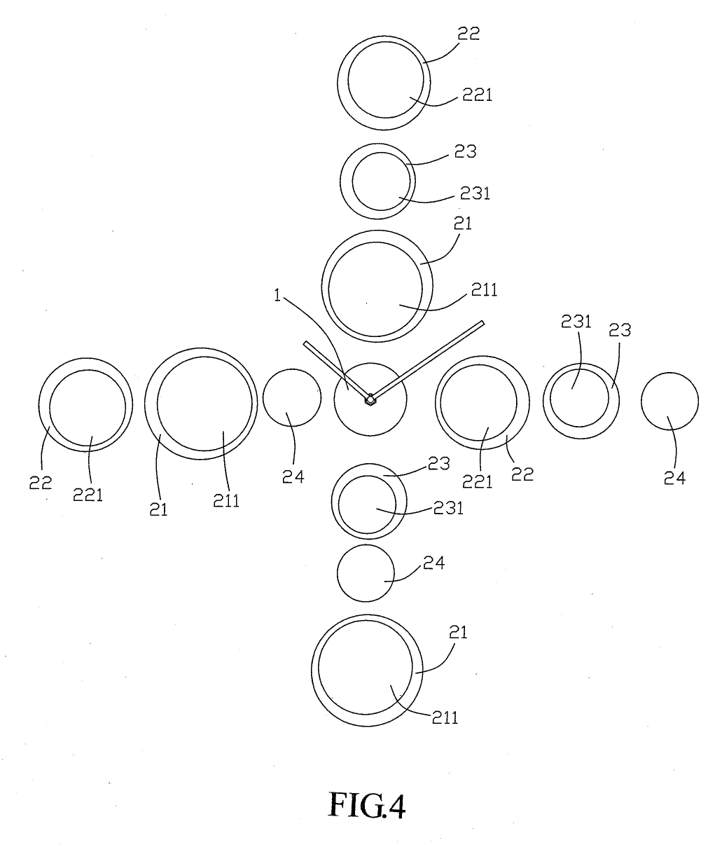

As shown in FIG. 4, the decorative scales 21, 22, 23 and 24 of the decorative scale unit 2 are arranged to form a cross-shaped profile.

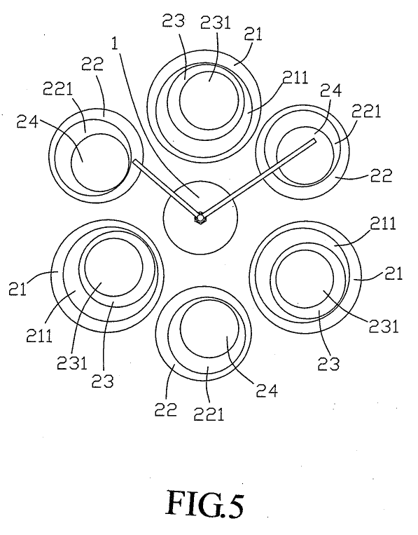

As shown in FIG. 5, the decorative scales 21, 22, 23 and 24 of the decorative scale unit 2 are arranged to form a circular profile.

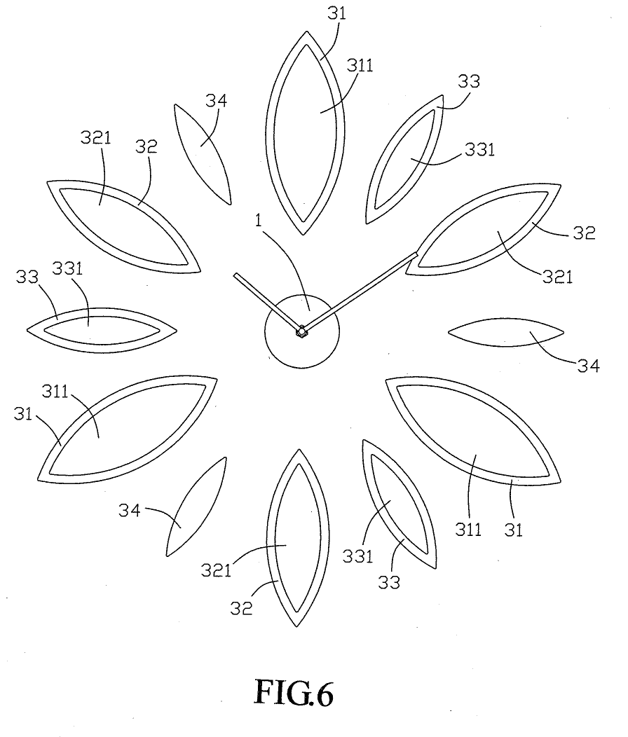

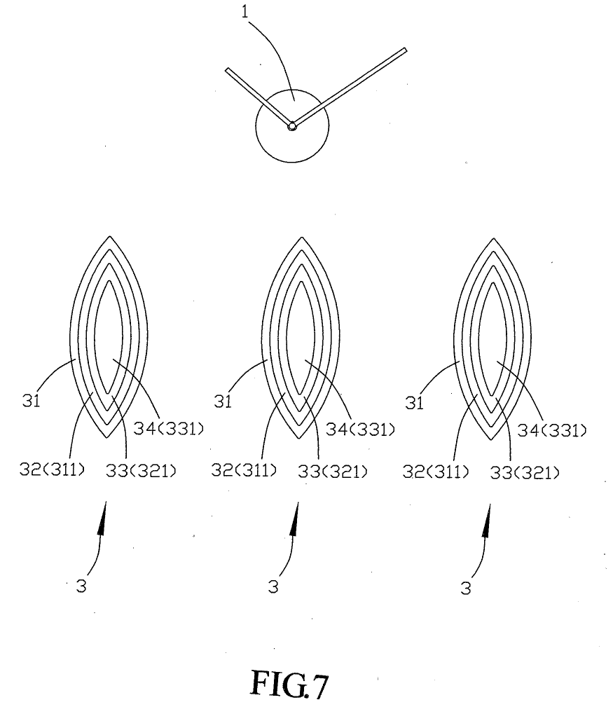

Referring to FIGS. 6 and 7, the decorative scale unit 3 includes a plurality of decorative scales 31, 32, 33 and 34 surrounding the tumbler 1, and each of the decorative scales 31, 32 and 33 of the decorative scale unit 3 has an inner portion provided with a receiving hole 311, 321 and 331. Each of the decorative scales 31, 32, 33 and 34 of the decorative scale unit 3 has a leaf shape, and the receiving hole 311, 321 and 331 of each of the decorative scales 31, 32 and 33 has a leaf shape.

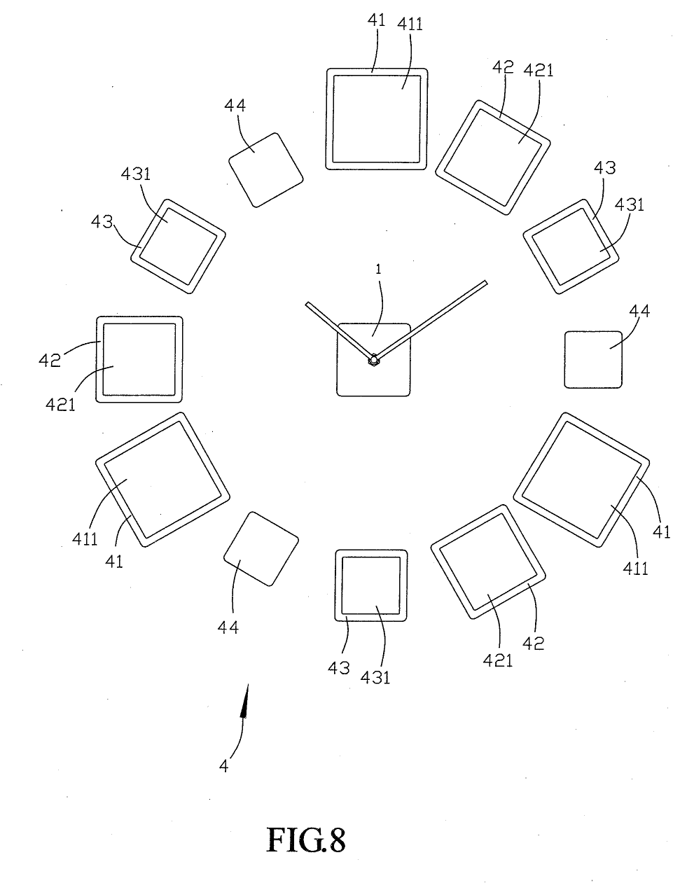

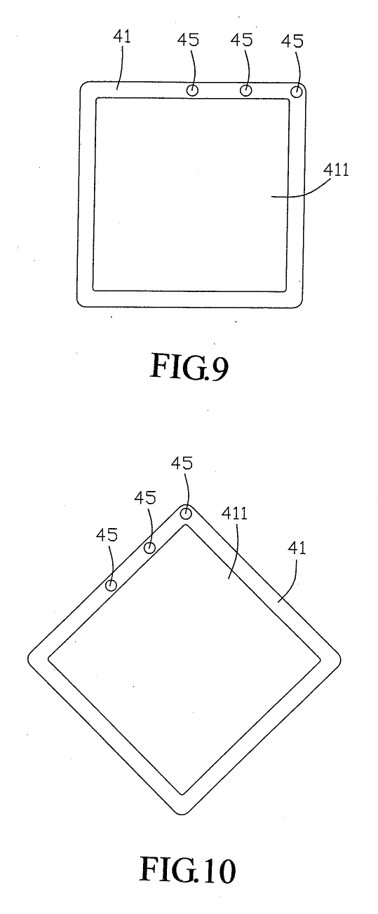

Referring to FIGS. 8-10, the decorative scale unit 4 includes a plurality of decorative scales 41, 42, 43 and 44 surrounding the tumbler 1, and each of the decorative scales 41, 42 and 43 of the decorative scale unit 4 has an inner portion provided with a receiving hole 411, 421 and 431. Each of the decorative scales 41, 42, 43 and 44 of the decorative scale unit 4 has a square shape, and the receiving hole 411, 421 and 431 of each of the decorative scales 41, 42 and 43 has a square shape. In addition, at least one of the decorative scales 41, 42, 43 and 44 of the decorative scale unit 4 has a periphery provided with at least one hanging hole 45 so that the decorative scales 41, 42, 43 and 44 of the decorative scale unit 4 have different inclined angle.

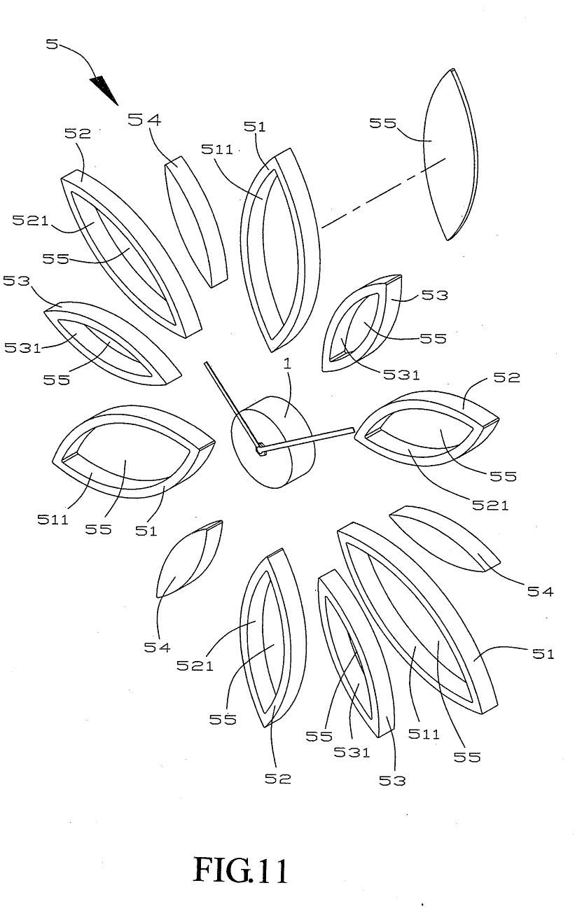

Referring to FIG. 11, the decorative scale unit 5 includes a plurality of decorative scales 51, 52, 53 and 54 surrounding the tumbler 1, and each of the decorative scales 51, 52 and 53 of the decorative scale unit 5 has an inner portion provided with a receiving hole 511, 521 and 531. In addition, the receiving hole 511, 521 and 531 of each of the decorative scales 51, 52 and 53 has a side provided with an image plate 55 to enhance the aesthetic quality of each of the decorative scales 51, 52 and 53. Preferably, the image plate 55 is a picture, photograph, paint and the like.

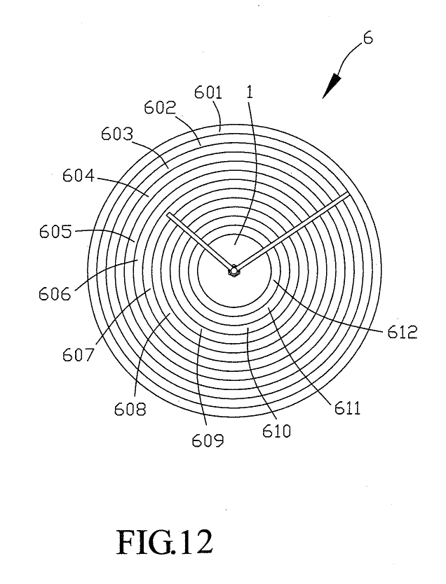

Referring to FIG. 12, the decorative scale unit 6 includes twelve decorative scales 601, 602, 603, 604, 605, 606, 607, 608, 609, 610, 611 and 612 surrounding the tumbler 1, and a smaller one of the decorative scales 601, 602, 603, 604, 605, 606, 607, 608, 609, 610, 611 and 612 is received in a larger one of the decorative scales 601, 602, 603, 604, 605, 606, 607, 608, 609, 610, 611 and 612 so that the decorative scales 601, 602, 603, 604, 605, 606, 607, 608, 609, 610, 611 and 612 are integrally combined together.

Accordingly, the decorative scale unit includes a plurality of decorative scales surrounding the tumbler so that the clock has an outstanding outer appearance. In addition, a smaller one of the decorative scales of the decorative scale unit is received in a larger one of the decorative scales so that the decorative scales encircle each other before assembly to reduce the whole volume of the decorative scale unit, thereby facilitating and decreasing the cost of packaging, storage and transportation of the clock. Further, the decorative scales of the decorative scale unit are arranged arbitrarily to form different geometric shapes according to requirements of different users, thereby greatly enhancing the aesthetic quality of the clock.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A clock, comprising:
a tumbler;
a decorative scale unit including a plurality of decorative scales surrounding the tumbler.

2. The clock of claim 1, wherein
the tumbler is located at a center of the decorative scales of the decorative scale unit;
the decorative scales of the decorative scale unit are arranged to form a geometric shape.

3. The clock of claim 1, wherein the decorative scales of the decorative scale unit have different sizes.

4. The clock of claim 3, wherein the sizes of the decorative scales are reduced gradually according to a determined proportion.

5. The clock of claim 1, wherein the decorative scales of the decorative scale unit have the same shape.

6. The clock of claim 1, wherein each of the decorative scales of the decorative scale unit has a hollow structure.

7. The clock of claim 1, wherein each of the decorative scales of the decorative scale unit has an inner portion provided with a receiving hole.

8. The clock of claim 7, wherein the receiving hole of each of the decorative scales has a shape the same as that of each of the decorative scales of the decorative scale unit.

9. The clock of claim 7, wherein the receiving hole of each of the decorative scales is arranged eccentrically in each of the decorative scales.

10. The clock of claim 7, wherein
a smaller one of the decorative scales of the decorative scale unit is received in the receiving hole of a larger one of the decorative scales;
the decorative scales encircle each other before assembly.

11. The clock of claim 1, wherein the decorative scales of the decorative scale unit have different colors.

12. The clock of claim 1, wherein the decorative scales of the decorative scale unit are located at different heights.

13. The clock of claim 1, wherein the smallest one of the decorative scales of the decorative scale unit has a solid structure.

14. The clock of claim 1, wherein at least one of the decorative scales of the decorative scale unit has a periphery provided with at least one hanging hole.

15. The clock of claim 7, wherein the receiving hole of each of the decorative scales has a side provided with an image plate.

16. The clock of claim 1, wherein
the tumbler is attached to a wall;
the decorative scales of the decorative scale unit are attached to the wall.

17. The clock of claim 7, wherein
each of the decorative scales of the decorative scale unit has a circular shape;
the receiving hole of each of the decorative scales has a circular shape.

18. The clock of claim 7, wherein
each of the decorative scales of the decorative scale unit has a leaf shape;
the receiving hole of each of the decorative scales has a leaf shape.

19. The clock of claim 7, wherein
each of the decorative scales of the decorative scale unit has a square shape;
the receiving hole of each of the decorative scales has a square shape.

20. The clock of claim 2, wherein the decorative scales of the decorative scale unit are arranged to form a cross-shaped profile.
